(19) United States
(12) Patent Application Publication
(10) Pub. No.: US 2017/0299287 A1
(43) Pub. Date: Oct. 19, 2017

(54) MULTI-REGION HEAT EXCHANGER

(71) Applicant: Hamilton Sundstrand Corporation, Charlotte, NC (US)

(72) Inventors: Lubomir A. Ribarov, West Hartford, CT (US); Leo J. Veilleux, JR., Wethersfield, CT (US)

(21) Appl. No.: 15/098,944

(22) Filed: Apr. 14, 2016

(51) Int. Cl. F28F 19/00; F28F 3/08; B64D 37/34; F28D 9/00; F28F 21/06; F28F 13/06

(52) U.S. Cl. CPC F28F 19/006; F28F 21/065; F28F 13/06; B64D 37/34; F28D 9/0025; F28F 3/08

(57) ABSTRACT

A heat exchanger includes a first side of a heat exchanger layer with a first flow path, wherein the first flow path flows through a heat soak region and a flow region, and a second side of the heat exchanger layer with a second flow path in thermal communication with the first flow path, wherein an inlet of the first flow path and an inlet of the second flow path are proximate in the heat soak region.

### BACKGROUND

The subject matter disclosed herein relates to heat exchangers, and more particularly, to fuel/oil coolers for aircraft.

Heat exchangers can be utilized within an aircraft to transfer heat from one fluid to another. Aircraft heat exchangers can transfer heat from oil to fuel to simultaneously cool oil and heat fuel prior to combustion. Often, heat exchangers may receive frozen or freezing fuel which may block flow channels within heat exchangers.

### BRIEF SUMMARY

According to an embodiment, a heat exchanger includes a first side of a heat exchanger layer with a first flow path, wherein the first flow path flows through a heat soak region and a flow region, and a second side of the heat exchanger layer with a second flow path in thermal communication with the first flow path, wherein the second flow path flows through the heat soak region and the flow region, wherein an inlet of the first flow path and an inlet of the second flow path are proximate in the heat soak region.

Technical function of the embodiments described above includes that an inlet of the first flow path and an inlet of the second flow path are proximate in the heat soak region.

Other aspects, features, and techniques of the embodiments will become more apparent from the following description taken in conjunction with the drawings.

### BRIEF DESCRIPTION OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the FIGURES:

FIG. 1A is a pictorial view of a fuel side of one embodiment of a layer of a cross-counter flow heat exchanger;

FIG. 1B is a pictorial view of an oil side of the layer of a cross-counter flow heat exchanger of FIG. 1A;

FIG. 2A is a pictorial view of a fuel side of one embodiment of a layer of a cross-counter flow heat exchanger;

FIG. 2B is a pictorial view of an oil side of the layer of a cross-counter flow heat exchanger of FIG. 2A;

FIG. 3A is a pictorial view of a fuel side of one embodiment of a layer of a cross-parallel flow heat exchanger;

FIG. 3B is a pictorial view of an oil side of the layer of a cross-parallel flow heat exchanger of FIG. 3A.

### DETAILED DESCRIPTION

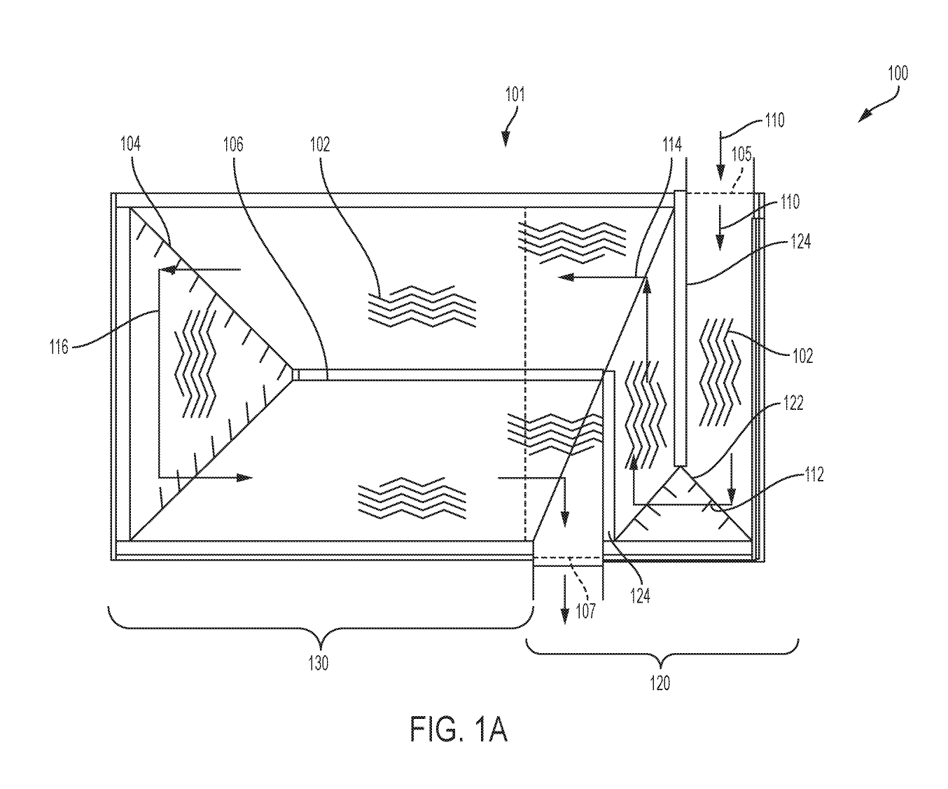

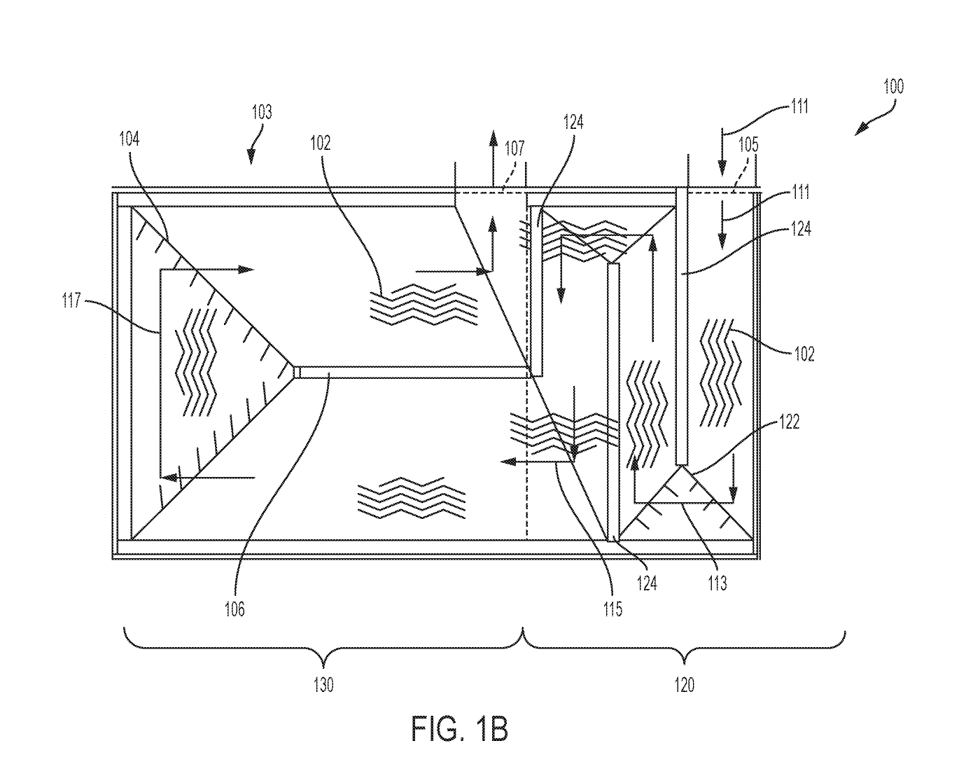

Referring to the drawings, FIGS. 1A and 1B show a heat exchanger 100. In the illustrated embodiment, the heat exchanger 100 includes at least one layer having a fuel side 101 and an oil side 103 disposed opposite to the fuel side 101. A heat exchanger 100 can include multiple layers each including a fuel side 101 and an oil side 103 contingent on the cooling and heat transfer requirements of the application. In the illustrated embodiment, the heat exchanger 100 can be utilized to exchange heat between a fuel flow 110 and an oil flow 111. Advantageously, the heat exchanger 100 can minimize freezing conditions in the fuel flow 110 that may cause flow restrictions within the heat exchanger 100 while removing the desired amount of heat from the oil flow 111. Further, the heat exchanger 100 can utilize a compact and light weight construction.

In the illustrated embodiment, both the fuel side 101 of the heat exchanger layer and the oil side 103 of the heat exchanger layer include an inlet 105, an outlet 107, channels 102, an extended heat soak region 120 and a cross-counter flow section 130. While the fuel side 101 and oil side 103 are designated for use with specific fluids, the heat exchanger 100 can be utilized with any suitable fluid and across fluid phases, such as liquid-vapor. Advantageously, the extended heat soak region 120 of the fuel side 101 and the oil side 103 allows enhanced heat transfer between flows to provide desired thermal characteristics in a compact configuration.

In the illustrated embodiment, the fuel flow 110 on fuel side 101 and oil flow 111 on oil side 103 is directed through channels 102 on each respective side. The channels 102 are formed by a plurality of flow passages defined between alternating sidewalls. The sidewalls have a first portion extending in one direction across a nominal flow direction, and leading into a second wall portion extending in an opposed direction. The overall effect is that the flow paths resemble herringbone designs. In the illustrated embodiment, fuel flow 110 and oil flow 111 can effectively transfer heat via channels 102. Advantageously, the resulting high density fin count that is provided allows high heat transfer between the fuel flow 110 and the oil flow 111 on opposite sides of a layer of the heat exchanger, thus, increasing the effectiveness of the heat exchanger 100. Advantageously, herringbone type heat exchangers 100 are optimized for conventional stack up builds, such as plate-fin heat exchangers with separating/parting solid sheets.

Referring to FIG. 1A, the flow path of the fuel flow 110 within the fuel side 101 of a heat exchanger layer is shown. In the illustrated embodiment, the fuel flow 110 enters the inlet 105 into the extended heat soak region 120. The fuel flow within the extended heat soak region 120 is identified as fuel flow 112. The fuel flow transitions into the fuel flow 114 of the cross-counter flow region 130 of the fuel side 101 of the heat exchanger layer. The fuel flow 116 continues and exits the heat exchanger 100 via the outlet 107. In the illustrated embodiment, the fuel flow 110 is any suitable fuel, while in other embodiments; the fuel flow 110 can be representative of any suitable fluid flow for use in a heat exchanger 100.

Similarly, referring to FIG. 1B, the flow path of the oil flow 111 within the oil side 103 of a heat exchanger layer is shown. In the illustrated embodiment, the oil flow 111 enters the inlet 105 into the extended heat soak region 120. The oil flow within the extended heat soak region 120 is identified as oil flow 113. The oil flow transitions into the oil flow 115 of the cross-counter flow region 130 of the oil side 103 of the heat exchanger layer. The oil flow 117 continues and exits the heat exchanger 100 via the outlet 107. In the illustrated embodiment, the oil flow 111 is any suitable oil, while in other embodiments; the oil flow 110 can be representative of any suitable fluid flow for use in a heat exchanger 100.

Referring to both FIGS. 1A and 1B, in the illustrated embodiment, the extended heat soak region 120 allows both the fuel flow 110 and the oil flow 111 to transfer heat across the layer of the heat exchanger 100 in a parallel flow configuration. Further, residence time within the extended heat soak region 120 is increased by increasing the distance of both the fuel flow 110 path and the oil flow 111 path.

In the illustrated embodiment, the inlet 105 of the fuel side 101 is disposed above the inlet 105 of the oil side 103. The extended heat soak region 120 allows for a greater temperature differential between the fuel flow 110 and the oil flow 111 to allow for maximum heat transfer as both flows enter the inlet 105. The use of the extended heat soak region 120 can prevent low temperatures that may cause resident dissolved water (below 4 degrees Celsius) or other condensed moisture from freezing in the fuel. Advantageously, the extended heat soak region 120 prevents the formation of ice in the fuel by transferring heat from the hottest portion of the oil flow 111 to the coldest portion of the fuel flow 110. The extended heat soak region 120 can prevent the formation of ice in the fuel and prevent excessively high pressure in the fuel side 101 (due to higher viscosity of the freezing fuel and freezing fuel/water mixture) within a herringbone type heat exchanger 100.

Within the extended heat soak region 120, fuel flow 110 and oil flow 111 can be directed by utilizing spacing bars 124. In the illustrated embodiment, spacing bars 124 can direct flow in an intended direction as flow travels within channels 102. In the illustrated embodiment, mitered interfaces 122 can be utilized to turn or otherwise redirect flow to create a longer flow path or an otherwise desired flow path. As shown, the herringbone walls of the channels 102 define herringbone-shaped flow passages in the flow paths for the fuel flow 110 and the oil flow 111. Advantageously, enlarged openings within the mitered interfaces 122 allow for greater tolerances between channels 102 directed in different directions. With enlarged openings within the mitered interfaces 122 there is less likelihood that there would be flow blockage between the channels 102 as the flow direction is changed. Advantageously, the use of mitered interfaces 122 and the enlarged openings within these mitered interfaces 122 can prevent excessive pressure build up within the heat exchanger 100.

As fuel flow 110 and oil flow 111 continues beyond the extended heat soak region 120, the flows enter the cross-counter flow region 130. In the illustrated embodiment, heat transfer between the fuel flow 110 and the oil flow 111 can continue to flow in a cross-counter flow to provide the desired heat transfer characteristics. The flow path within the cross-counter flow region 130 can be determined by cooling needs, packaging requirements, etc. Similarly, within the cross-counter flow region 130, fuel flow 110 and oil flow 111 can be directed by utilizing spacing bars 106. In the illustrated embodiment, spacing bars 106 can direct flow in an intended direction as flow travels within channels 102. In the illustrated embodiment, mitered interfaces 104 can be utilized to turn or otherwise redirect flow to create a longer flow path or an otherwise desired flow path. Advantageously, the use of mitered interfaces 104 can prevent excessive pressure build up within the heat exchanger 100. Advantageously, both the oil inlet 105 and the oil outlet 107 of the oil side 103 of the heat exchanger 100 are located on the same side of the heat exchanger 100. This configuration facilitates more efficient packaging of the overall heat exchanger 100.

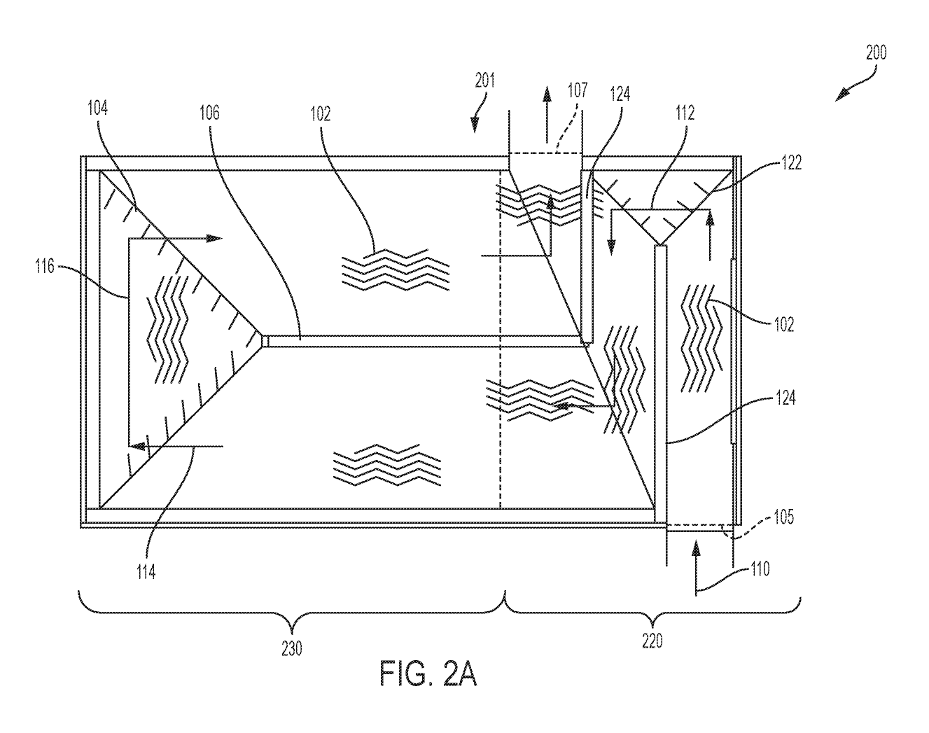

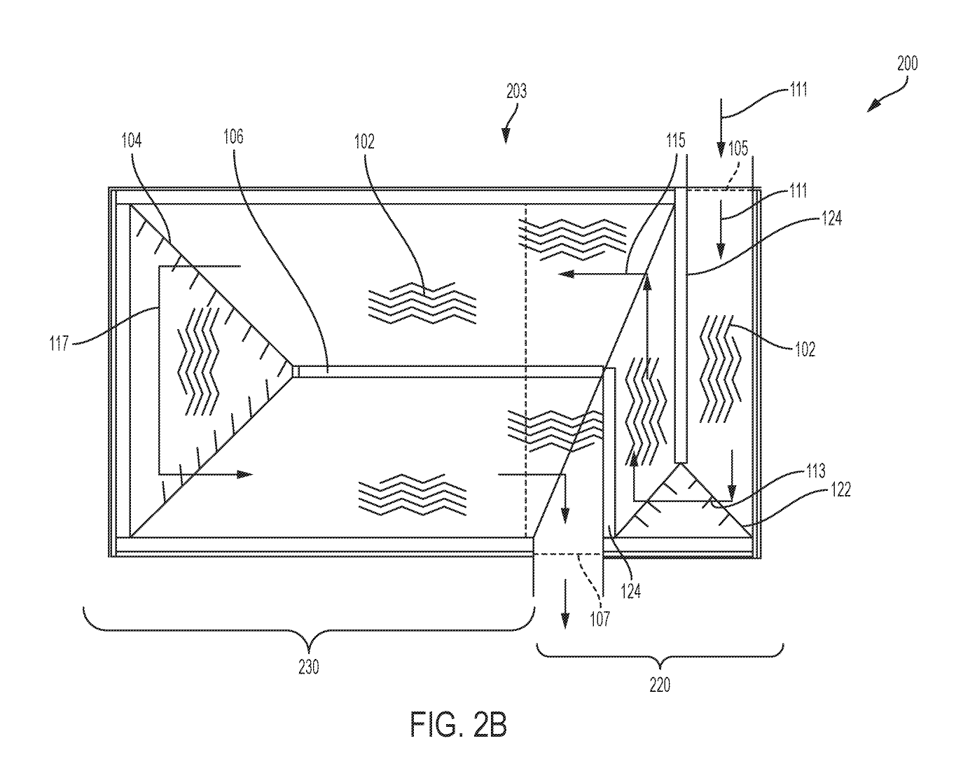

Referring to FIGS. 2A and 2B, an alternative embodiment of a heat exchanger 200 is shown. In the illustrated embodiment, the extended heat soak region 220 utilizes a cross-counter flow relationship between the fuel flow 110 and the oil flow 111 of the fuel side 201 and the oil side 203. In the illustrated embodiment, the inlet 105 of the fuel side 201 is disposed on the opposite heat exchanger side to the inlet 105 of the oil side 203. Advantageously, the extended heat soak region 220 configuration allows for a greater temperature differential between the fuel flow 110 and the oil flow 111 since the inlets 105 are disposed on the opposite heat exchanger side to each other to allow for maximum heat transfer as both flows enter the respective inlets 105. Similarly, in the illustrated embodiment, the extended heat soak region 230 allows for increased residence time within the extended heat soak region 230 by increase the distance of both the fuel flow path 110 and the oil flow path 111. In the illustrated embodiment, fuel flow 110 and oil flow 111 continues to the cross-counter flow region 230 of each layer of the heat exchanger 200.

Within the extended heat soak region 220, fuel flow 110 and oil flow 111 can be directed by utilizing spacing bars 124. In the illustrated embodiment, spacing bars 124 can direct flow in an intended direction as flow travels within channels 102. In the illustrated embodiment, mitered interfaces 122 can be utilized to turn or otherwise redirect flow to create a longer flow path or an otherwise desired flow path. As shown, the herringbone walls of the channels 102 define herringbone-shaped flow passages in the flow paths for the fuel flow 110 and the oil flow 111. Advantageously, enlarged openings within the mitered interfaces 122 allow for greater tolerances between channels 102 directed in different directions. With enlarged openings within the mitered interfaces 122 there is less likelihood that there would be flow blockage between the channels 102 as the flow direction is changed. Advantageously, the use of mitered interfaces 122 and the enlarged openings within these mitered interfaces 122 can prevent excessive pressure build up within the heat exchanger 200.

As fuel flow 110 and oil flow 111 continues beyond the extended heat soak region 220, the flows enter the cross-counter flow region 230. In the illustrated embodiment, heat transfer between the fuel flow 110 and the oil flow 111 can continue to flow in a cross-counter flow to provide the desired heat transfer characteristics. The flow path within the cross-counter flow region 230 can be determined by cooling needs, packaging requirements, etc. Similarly, within the cross-counter flow region 230, fuel flow 110 and oil flow 111 can be directed by utilizing spacing bars 106. In the illustrated embodiment, spacing bars 106 can direct flow in an intended direction as flow travels within channels 102. In the illustrated embodiment, mitered interfaces 104 can be utilized to turn or otherwise redirect flow to create a longer flow path or an otherwise desired flow path. Advantageously, the use of mitered interfaces 104 can prevent excessive pressure build up within the heat exchanger 200.

Referring to FIG. 2A, the flow path of the fuel flow 110 within the fuel side 201 of a heat exchanger layer is shown. In the illustrated embodiment, the fuel flow 110 enters the inlet 105 into the extended heat soak region 220. The fuel flow within the extended heat soak region 220 is identified as fuel flow 112. The fuel flow transitions into the fuel flow 114 of the cross-counter flow region 230 of the fuel side 201 of the heat exchanger layer. The fuel flow 116 continues and exits the heat exchanger 200 via the outlet 107. In the illustrated embodiment, the fuel flow 110 is any suitable fuel, while in other embodiments the fuel flow 110 can be representative of any suitable fluid flow for use in a heat exchanger 200.

Similarly, referring to FIG. 2B, the flow path of the oil flow 111 within the oil side 203 of a heat exchanger layer is shown. In the illustrated embodiment, the oil flow 111 enters the inlet 105 into the extended heat soak region 220. The oil flow within the extended heat soak region 220 is identified as oil flow 113. The oil flow transitions into the oil flow 115 of the cross-counter flow region 230 of the oil side 203 of the heat exchanger layer. The oil flow 117 continues and exits the heat exchanger 200 via the outlet 107. In the illustrated embodiment, the oil flow 111 is any suitable oil, while in other embodiments; the oil flow 110 can be representative of any suitable fluid flow for use in a heat exchanger 200.

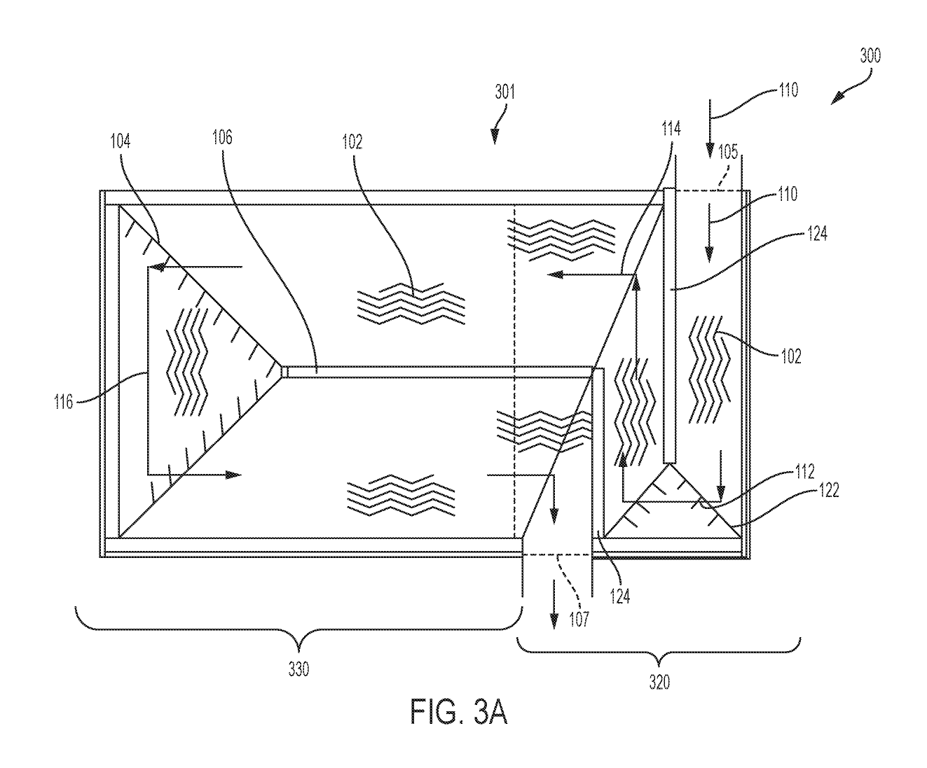

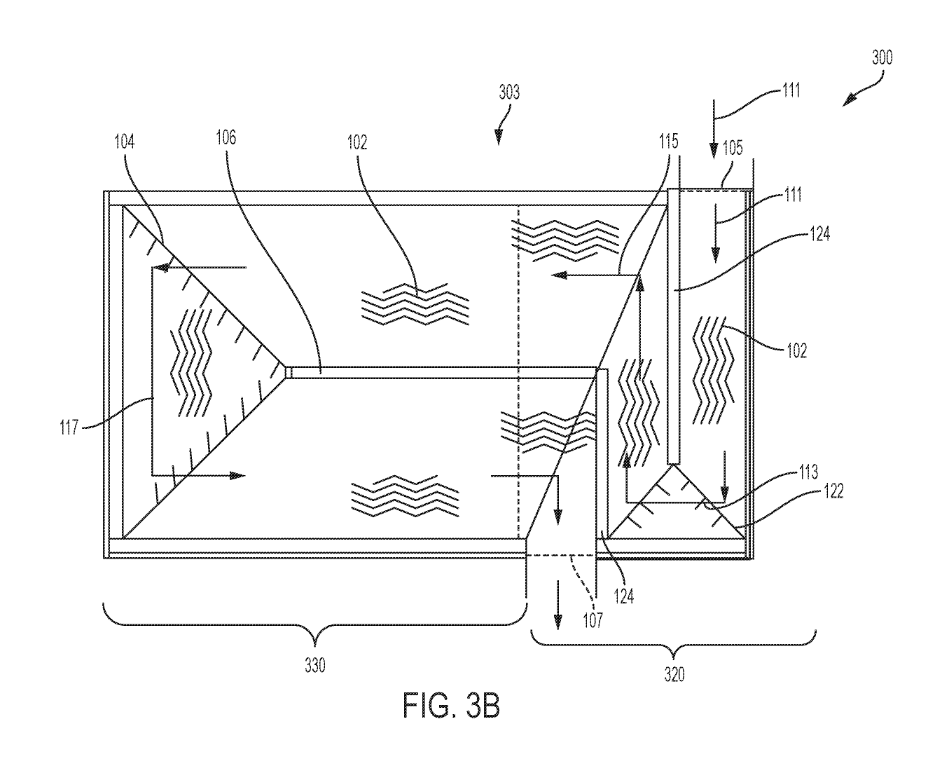

Referring to FIGS. 3A and 3B, an alternative embodiment of a heat exchanger 300 is shown. In the illustrated embodiment, the extended heat soak region 320 utilizes a cross parallel flow relationship between the fuel flow 110 and the oil flow 111 of the fuel side 301 and the oil side 303. Advantageously, the extended heat soak region 320 configuration allows for a greater temperature differential between the fuel flow 110 and the oil flow 111 since the inlets 105 are disposed on the same sides of the heat exchanger 300 layer to allow for maximum compactness while maintaining a high level of heat transfer as both flows enter their respective inlets 105. In the illustrated embodiment, fuel flow 110 and oil flow 111 continues to the cross parallel flow region 330 of each layer of the heat exchanger 300. In certain embodiments, the cross-parallel flow region 330 can allow for a more compact design or configuration of inlets 105 and outlets 107.

Within the extended heat soak region 320, fuel flow 110 and oil flow 111 can be directed by utilizing spacing bars 124. In the illustrated embodiment, spacing bars 124 can direct flow in an intended direction as flow travels within channels 102. In the illustrated embodiment, mitered interfaces 122 can be utilized to turn or otherwise redirect flow to create a longer flow path or an otherwise desired flow path. As shown, the herringbone walls of the channels 102 define herringbone-shaped flow passages in the flow paths for the fuel flow 110 and the oil flow 111. Advantageously, enlarged openings within the mitered interfaces 122 allow for greater tolerances between channels 102 directed in different directions. With enlarged openings within the mitered interfaces 122 there is less likelihood that there would be flow blockage between the channels 102 as the flow direction is changed. Advantageously, the use of mitered interfaces 122 and the enlarged openings within these mitered interfaces 122 can prevent excessive pressure build up within the heat exchanger 100.

As fuel flow 110 and oil flow 111 continues beyond the extended heat soak region 320, the flows enter the cross-counter flow region 330. In the illustrated embodiment, heat transfer between the fuel flow 110 and the oil flow 111 can continue to flow in a cross-counter flow to provide the desired heat transfer characteristics. The flow path within the cross-counter flow region 330 can be determined by cooling needs, packaging requirements, etc. Similarly, within the cross-counter flow region 330, fuel flow 110 and oil flow 111 can be directed by utilizing spacing bars 106. In the illustrated embodiment, spacing bars 106 can direct flow in an intended direction as flow travels within channels 102. In the illustrated embodiment, mitered interfaces 104 can be utilized to turn or otherwise redirect flow to create a longer flow path or an otherwise desired flow path. Advantageously, the use of mitered interfaces 104 can prevent excessive pressure build up within the heat exchanger 300. Advantageously, both the fuel inlet 105 of the fuel side 301 and the oil inlet 105 of the oil side 303 of the heat exchanger 300 are located on the same side of the heat exchanger 300. Equally advantageously, both the fuel outlet 107 of the fuel side 301 and the oil outlet 107 of the oil side 303 of the heat exchanger 300 are located on the same side of the heat exchanger 300. This configuration facilitates more efficient packaging and compact design of the overall heat exchanger 300.

Referring to FIG. 3A, the flow path of the fuel flow 110 within the fuel side 301 of a heat exchanger layer is shown. In the illustrated embodiment, the fuel flow 110 enters the inlet 105 into the extended heat soak region 320. The fuel flow within the extended heat soak region 320 is identified as fuel flow 112. The fuel flow transitions into the fuel flow 114 of the cross-counter flow region 330 of the fuel side 201 of the heat exchanger layer. The fuel flow 116 continues and exits the heat exchanger 300 via the outlet 107. In the illustrated embodiment, the fuel flow 110 is any suitable fuel, while in other embodiments; the fuel flow 110 can be representative of any suitable fluid flow for use in a heat exchanger 300.

Similarly, referring to FIG. 3B, the flow path of the oil flow 111 within the oil side 303 of a heat exchanger layer is shown. In the illustrated embodiment, the oil flow 111 enters the inlet 105 into the extended heat soak region 320. The oil flow within the extended heat soak region 320 is identified as oil flow 113. The oil flow transitions into the oil flow 115 of the cross-counter flow region 330 of the oil side 303 of the heat exchanger layer. The oil flow 117 continues and exits the heat exchanger 300 via the outlet 107. In the illustrated embodiment, the oil flow 111 is any suitable oil, while in other embodiments; the oil flow 111 can be representative of any suitable fluid flow for use in a heat exchanger 300.

In certain embodiments, the heat exchanger described herein can be used with two vapor-phase fluid streams for providing cooled air stream. In certain embodiments, the heat exchanger can be used with fluids, at least one of which may be a phase-changing fluid, such as (but not limited to) refrigeration fluids. In certain embodiments, the heat exchanger can be used with fluids, at least one of which may be a mixture of a phase-changing fluid and water, such as (but not limited to) propylene-glycol-water (PGW), ethylene-glycol-water (EGW), etc.

In certain embodiments, the heat exchanger structures described herein can be manufactured by conventional techniques such as metal-forming techniques to stamp the herringbone conduits/channels into the proper configuration to accommodate the intended heat exchanger performance. The materials are not limited to metals and for some applications, polymer heat exchangers can also be utilized. In certain embodiments, additive manufacturing is used to fabricate any part of or all of the heat exchanger structures. Additive manufacturing techniques can be used to produce a wide variety of structures that are not readily producible by conventional manufacturing techniques.

In certain embodiments, the heat exchanger can be manufactured by advanced additive manufacturing (“AAM”) techniques such as (but not limited to): selective laser sintering (SLS) or direct metal laser sintering (DMLS), in which a layer of metal or metal alloy powder is applied to the workpiece being fabricated and selectively sintered according to the digital model with heat energy from a directed laser beam. Another type of metal-forming process includes selective laser melting (SLM) or electron beam melting (EBM), in which heat energy provided by a directed laser or electron beam is used to selectively melt (instead of sinter) the metal powder so that it fuses as it cools and solidifies.

In certain embodiments, the heat exchanger can made of a polymer, and a polymer or plastic forming additive manufacturing process can be used. Such process can include stereolithography (SLA), in which fabrication occurs with the workpiece disposed in a liquid photopolymerizable composition, with a surface of the workpiece slightly below the surface. Light from a laser or other light beam is used to selectively photopolymerize a layer onto the workpiece, following which it is lowered further into the liquid composition by an amount corresponding to a layer thickness and the next layer is formed.

Polymer components can also be fabricated using selective heat sintering (SHS), which works analogously for thermoplastic powders to SLS for metal powders. Another additive manufacturing process that can be used for polymers or metals is fused deposition modeling (FDM), in which a metal or thermoplastic feed material (e.g., in the form of a wire or filament) is heated and selectively dispensed onto the workpiece through an extrusion nozzle.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope and spirit of the embodiments. Additionally, while various embodiments have been described, it is to be understood that aspects may include only some of the described embodiments. Accordingly, the embodiments are not to be seen as limited by the foregoing description, but are only limited by the scope of the appended claims.

What is claimed is:

1. A heat exchanger, comprising:
a first side of a heat exchanger layer with a first flow path, wherein the first flow path flows through a heat soak region and a flow region; and
a second side of the heat exchanger layer with a second flow path in thermal communication with the first flow path, wherein the second flow path flows through the heat soak region and the flow region,
wherein an inlet of the first flow path and an inlet of the second flow path are proximate in the heat soak region.

2. The heat exchanger of claim 1, wherein the first flow path and the second flow path are in a parallel flow relationship in the heat soak region.

3. The heat exchanger of claim 1, wherein the first flow path and the second flow path are in a counter flow relationship in the heat soak region.

4. The heat exchanger of claim 1, wherein the heat exchanger layer includes a plurality of heat exchanger layers.

5. The heat exchanger of claim 1, wherein the first flow path and the second flow path are in a counter flow relationship in the flow region.

6. The heat exchanger of claim 1, wherein the first flow path and the second flow path are in a parallel flow relationship in the flow region.

7. The heat exchanger of claim 1, wherein the heat exchanger layer includes a plurality of channels for the first flow path and the second flow path.

8. The heat exchanger of claim 7, wherein the plurality of channels are a plurality of herringbone channels.

9. The heat exchanger of claim 1, wherein the heat exchanger includes at least one mitered interface.

10. The heat exchanger of claim 1, wherein the heat exchanger includes at least one spacer bar.

11. The heat exchanger of claim 1, wherein the first flow path receives a fuel flow.

12. The heat exchanger of claim 1, wherein the second flow path receives an oil flow.

13. The heat exchanger of claim 1, wherein the heat exchanger is formed using additive manufacturing.
